(19) United States
(12) Patent Application Publication
(10) Pub. No.: US 2025/0192969 A1
(43) Pub. Date: Jun. 12, 2025

(54) A METHOD AND DEVICE FOR FREQUENCY SELECTION

(71) Applicant: Sony Group Corporation, Tokyo (JP)

(72) Inventors: Kun ZHAO, Malmö (SE); Fredrik RUSEK, Eslöv (SE); Olof ZANDER, Södra Sandby (SE); Erik BENGTSSON, Eslöv (SE); Jose FLORDELIS, Lund (SE); Chaitanya TUMULA, Åkarp (SE)

(21) Appl. No.: 18/847,241

(22) PCT Filed: Mar. 17, 2023
(86) PCT No.: PCT/EP2023/056899

§ 371 Date: Sep. 14, 2024

(30) Foreign Application Priority Data
Mar. 31, 2022 (SE) 2250409-6

(51) Int. Cl. H04L 5/00; H04W 72/0453

(52) U.S. Cl. CPC H04L 5/0098; H04L 5/0048; H04W 72/0453

(57) ABSTRACT

A method, performed by a coverage enhancing device, comprising transmitting, to a network node, control signalling indicative of a location of at least one frequency component to be used for a first channel between the network node and a wireless device. The first channel is in addition to at least a second channel between the network node and the wireless device.

The present disclosure pertains to the field of wireless communications. The present disclosure relates to methods for transmission and reception of control signalling indicative of frequency components and to related devices.

### SUMMARY

A method, performed by a coverage enhancing device, may be provided. The method comprises transmitting, to a network node, control signalling indicative of a location of at least one frequency component to be used for a first channel between the network node and a wireless device. The first channel is in addition to at least a second channel between the network node and the wireless device. The at least one frequency component may comprise at least one carrier component.

A coverage enhancing device may be used for network management of a wireless communication system, such as for redirection of signals between a network node and a wireless device. When a coverage enhancing device is used in a wireless communication system, there may be a limitation in the band combinations that can be used for operations such as carrier aggregation. For example, the coverage enhancing device may have frequency dependent reflection properties for pairs of frequency components. Hence, the reflection of the signals on frequency components, such as carrier components, may lead to insufficient levels of channel gain.

The above method may be advantageous in that the control signalling may enable location of at least one frequency component, such as at least one carrier component, to be used as an additional channel (referred to as first channel) between the network node and the wireless device in addition to a second channel. Such first channel may therefore be selected, for a given configuration of the coverage enhancing device, to allow for a satisfactory level of channel gain.

Put another way, the method may enable an enhancement of the transmission bandwidth and a utilisation of incontiguous spectrum resources whilst achieving sufficient channel gain in the first and second channels.

A coverage enhancing device comprising memory circuitry, processor circuitry and a wireless interface may be provided. The coverage enhancing device is configured to perform any of the methods disclosed herein. Therefore, the coverage enhancing device may be advantageous for the same reasons as set forth for such methods.

A method, performed by a network node, may be provided. The method comprises receiving, from a coverage enhancing device, control signalling indicative of a location of at least one frequency component to be used for a first channel between the network node and a wireless device. The first channel is in addition to at least a second channel between the network node and the wireless device. The at least one frequency component may comprise at least one carrier component.

A network node comprising memory circuitry, processor circuitry and a wireless interface may be provided. The network node is configured to perform any of the methods disclosed herein.

The disclosed method performed by the network node and the disclosed network node may be advantageous for the same reasons as set forth for the disclosed method performed by the coverage enhancing device and the disclosed coverage enhancing device, that is, for example by enabling an enhancement of the transmission bandwidth and a utilisation of incontiguous spectrum resources whilst achieving sufficient channel gain in the first and second channels.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example coverage enhancing device and example wireless devices according to this disclosure.

FIG. 2 is a diagram illustrating an example wireless communication system comprising an example network node, an example coverage enhancing device and an example wireless device according to this disclosure.

FIG. 3 shows a channel gain schematic representation for a selected network node-CED-wireless device angle pair.

FIG. 4 illustrates a channel gain schematic representation for a selected network node-CED-wireless device angle pair different from that of FIG. 3.

FIG. 5 is a signalling diagram illustrating an example communication between a network node and a wireless device, according to this disclosure.

FIGS. 6A and 6B are a flow-chart illustrating an example method, performed in a coverage enhancing device of a wireless communication system, according to this disclosure.

FIGS. 7 and 7B are a flow-chart illustrating an example method, performed in a network node of a wireless communication system, according to this disclosure.

FIG. 8 is a block diagram illustrating an example coverage enhancing device according to this disclosure.

FIG. 9 is a block diagram illustrating an example network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

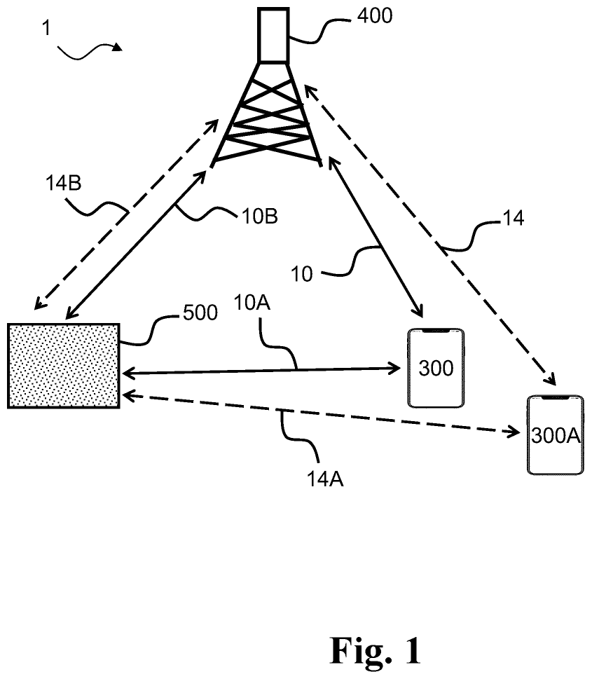

FIG. 1 is a diagram illustrating an example wireless communication system 1 comprising an example network node 400, example wireless devices 300, 300A and an example coverage enhancing device (CED) 500 according to this disclosure.

As discussed in detail herein, the present disclosure relates to a wireless communication system 1 comprising a cellular system, for example, a 3GPP wireless communication system. The wireless communication system 1 may comprise one or more wireless devices 300, 300A and one or more network nodes 400.

A network node disclosed herein refers to a radio access network node operating in the radio access network (RAN), such as one or more of: a base station, an evolved Node B, an eNB, a gNB in NR and an access point. In one or more examples, the RAN node is a functional unit which may be distributed in several physical units.

A wireless device may refer to one or more of: a mobile device and a user equipment (UE).

The wireless devices 300, 300A may be configured to communicate with the network node 400 via a wireless link (or radio access link) 10, 14 respectively.

The present disclosure may involve downlink (DL) and uplink (UL) transmissions.

The wireless communication system 1 of FIG. 1 may comprise one or more CEDs 500. The CED 500 may be configured to redirect signals between other components of the wireless communication system 1, such as the wireless devices 300, 300A and the network node 400.

In the embodiment of FIG. 1, a first wireless device 300 may be configured to communicate with the network node 400 via a first wireless link (or radio access link) 10A, 10B, in which the signals between the first wireless device 300 and the network node 400 are redirected by the CED 500. In the embodiment of FIG. 1, a second wireless device 300A may be configured to communicate with the network node 400 via a second wireless link (or radio access link) 14A, 14B, in which the signals between the first wireless device 300 and the network node 400 are redirected by the CED 500.

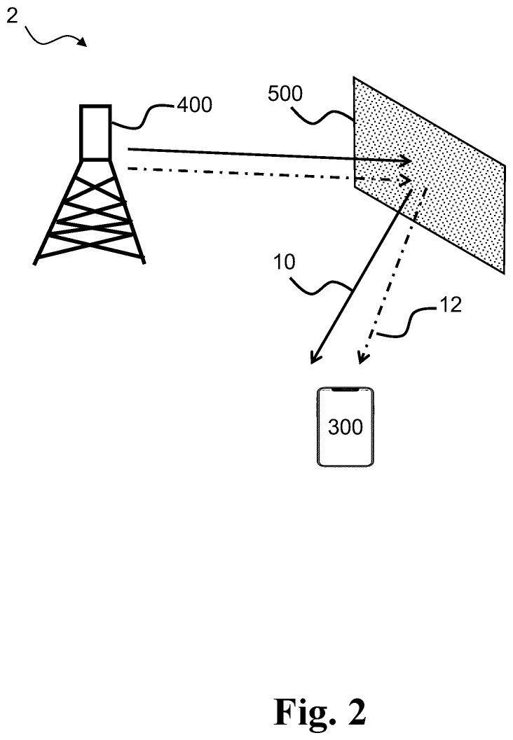

FIG. 2 illustrates an example wireless communication system 1 comprising a wireless device 300, a network node 400 and a CED 500. In the embodiment of FIG. 2, the wireless device 300 may be configured to communicate with the network node 400 via a wireless link (or radio access link) 10, 12, in which the signals between the first wireless device 300 and the network node 400 are redirected by the CED 500. Transmission between the wireless device 300 and the network node 400 may occur in a first frequency component 10, such as a first carrier component 10, centred at f₁, and a second frequency component 12, such as a second carrier component 12, centred at f₂.

As used herein, a frequency component, such as a carrier component, “located” at a certain frequency may be construed as a frequency component, such as a carrier component, “centred” at such frequency. A “location of a frequency component”, such as a “location of a carrier component”, may denote a centre frequency of the frequency component, such as the carrier component. A “location of a frequency component”, such as a “location of a carrier component”, may denote any other frequency of the frequency component, such as the carrier component, like a lower frequency, an upper frequency, or any other suitable reference frequency. In other words, a location of a frequency component refers to a frequency location of the frequency component, such as a centre frequency, a lower frequency or an upper frequency or any suitable reference frequency. For example, a frequency component, such as a carrier component, may denote a range of contiguous frequencies located around a centre frequency of such range of contiguous frequencies. Two or more frequency components, such as carrier components, may be used together (that is, the two or more frequency components, such as carrier components, may be aggregated). An aggregation of frequency components, such as carrier components, may be beneficial to expand the bandwidth of the wireless communication system. An aggregation of frequency components may enable UL and DL transmissions in frequency division duplex (FDD) communications in wireless communication systems comprising a CED.

The present disclosure can be applicable for connected state for FDD when the system allows changing the location of only the UL carrier or the DL carrier (for example, in future releases of a standard specification) and/or moving the bandwidth part of the DL carrier or the UL carrier within an FDD band (e.g. assuming that the band is wide).

As outlined above, there may be a limitation in the band combinations that can be used for operations such as carrier aggregation or FDD operation.

Some illustration, in form of equations, of this issue is shown below for an example. In this example, it is assumed that there is a single network node 400 and a single wireless device 300, and the goal is to support transmission in the first frequency component, such as the first carrier component, centred at f₁, and the second frequency component, such as the second carrier component, centred at f₂.

Let the frequency dependent, network node-CED steering vector be denoted s(f)=[s₁(f), s₂(f), . . . ], and the CED-wireless device steering vector be denoted by u(f)=[u₁(f), u₂(f), . . . ]. The processing at the CED can be denoted by a vector x(f, C)=[x₁(f, C), x₂(f, C), . . . ] where C may be tuneable variables that are applied at each antenna element to manipulate the reflection coefficients. The CED processing may be frequency dependent. For given variables C, the channel gains at f₁ and f₂ may be:

$$γ ( {f}_{1} , C ) = {\vert {\sum }_{m} {z}_{m} ( {f}_{1} ) {x}_{m} ( {f}_{1} , C ) \vert}^{2}$$

$$γ ( {f}_{2} , C ) = {\vert {\sum }_{m} {z}_{m} ( {f}_{2} ) {x}_{m} ( {f}_{2} , C ) \vert}^{2}$$

where zₘ(f)=uₘ(f)sₘ(f).

It may be an objective to find C such that min_{C}(γ(f₁, C), γ(f₂, C)) is maximised.

$$γ ( {f}_{1} , {f}_{2} ) = {max}_{C} min ( γ ( {f}_{1} , C ) , γ ( {f}_{2} , C ) ) )$$

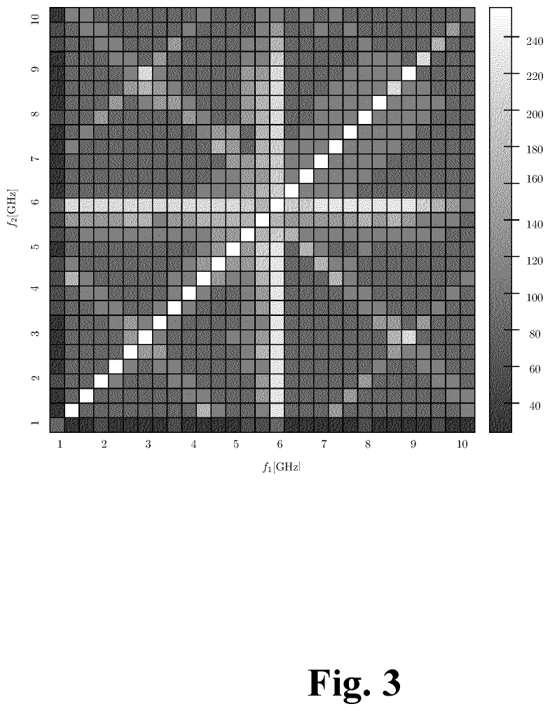

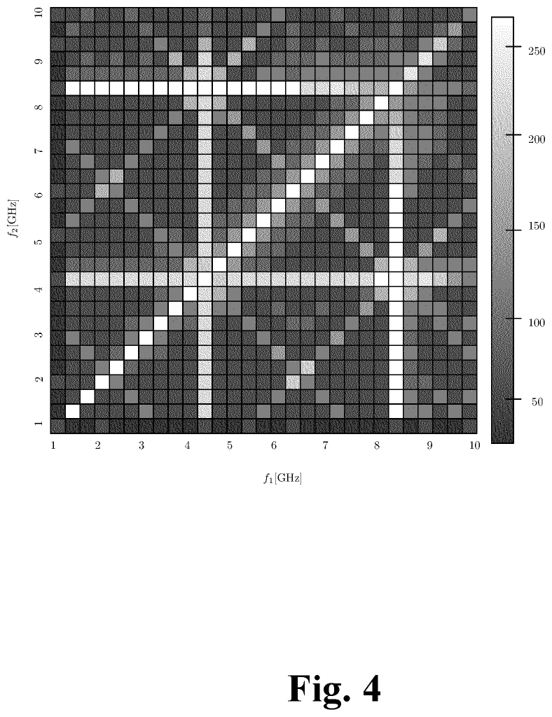

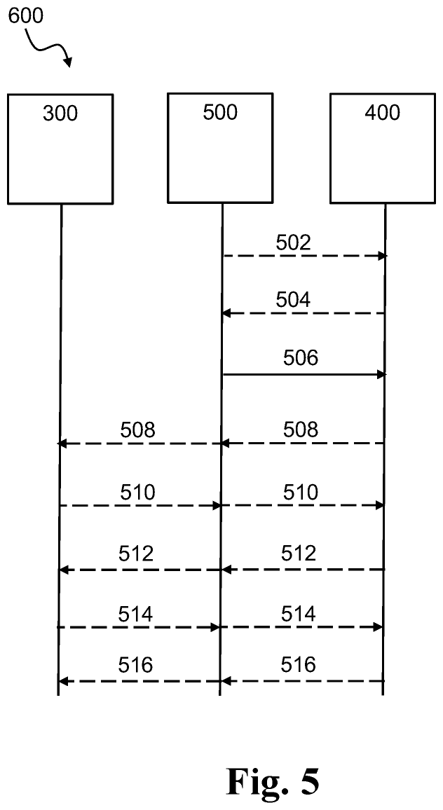

FIG. 3 and FIG. 4 below show examples of the resulting function [symbol] (f₁, f₂) for two randomly selected network node-CED-wireless device angle pairs. A network node-CED-wireless device angle pair is a type of angle information. The example is made for 16 CED antennas, wherefore maximum channel gain may be 256 whenever, in an example, x(f,C) is limited to complex exponentials.

FIG. 3 and FIG. 4 illustrate that, for both angle pairs, it may be possible to select values f₁ and f₂ that give rise to channel gains only marginally below the maximum channel gain. In these examples, the main diagonal might not be meaningful as then both transmissions would take place at overlapping frequencies, that is, there would not be a location of a first frequency component and a location of a second frequency component different from the location of the first frequency component.

The example plot in FIG. 3 implies that if one transmission is centred (that is, located) at a first frequency component of about 6 GHz, the location of the second frequency component may essentially be randomly allocated without affecting the channel gain value. Such location of a first frequency component, such as a first carrier component, may be referred to as an optimised location of a frequency component, such as an optimised location of a carrier component.

In the example of FIG. 4, the same CED 500 as in the example of FIG. 3 is used but simulated with another randomly selected network node-CED-wireless device angle pair. In this case, if one transmission is centred at first frequency components of about 4 GHz or about 8 GHz, the location of the second frequency component may essentially be randomly allocated without affecting the channel gain value. As shown in FIG. 4, there may be more than one optimised locations of frequency components, such as more than one optimised locations of carrier components, within the frequency of interest.

Angle information can be seen as information related to an angle, such as a spherical angle, between the coverage enhancing device and the wireless device. In one or more examples, the angle information comprises an angle between the coverage enhancing device and the network node. In one or more examples, the angle information comprises the angle between the coverage enhancing device and the wireless device and the angle between the coverage enhancing device and the network node (such as a network node-CED-wireless device angle pair). As used herein, “angle between the coverage enhancing device and the wireless device” is construed as the direction between the geometrical centre of the coverage enhancing device and the geometrical centre of the wireless device. As used herein, “angle between the coverage enhancing device and the network node” is construed as the direction between the geometrical centre of the coverage enhancing device and the geometrical centre of the network node.

As has been explained, the optimal frequency bands may depend on angle information, such as the network node-CED-wireless device angle pairs. When a CED is included in a communication system, it may be advisable not to select the locations of carrier components or other frequency components arbitrarily. Instead, it may be advisable to relate the CED implementation to the network node-CED-wireless device angle pair.

It may be observed in FIG. 3 and FIG. 4 that channel gain may vary significantly between frequency component pairs.

When a CED is not used in a wireless communication system, the network node may sound through the spectrum to determine which carrier component combination (or, more generally, frequency component combination) should be used, since there may be no degradation in channel gain per carrier component when combining multiple carrier components (assuming that the network node and the wireless device are ideal components without any RF impairments). In contrast, when a CED is used in a wireless communication system, the network node would typically sound, in an approach, through all the possible carrier components combinations (or, more generally, frequency component combinations) to determine the optimised combination. For example, for n frequency components, the network node would sound through n² combinations.

The methods disclosed herein aim at reducing the number of combinations the network node may sound to determine such optimised combination.

Components of the disclosed CEDs, such as the active components and passive components, can be advantageous to redirect signals. As disclosed herein, redirecting can include one or more of: transmitting, reflecting, forwarding, scattering, regenerating, re-radiating, directing, retransmitting a signal, and allowing a signal to pass through. Redirecting, transmitting, and retransmitting may be used interchangeably. The redirecting may include altering direction, polarisation or both direction and polarisation of a signal. The redirecting may include one or more of: amplification, attenuation, termination, phase shifting, delaying and spatial manipulation of a signal. The redirecting may also add a wave in front of the signal. Spatial manipulation may be, for instance, splitting into multiple components, widening or in general applying any spatial filtering.

For example, the CEDs may redirect an incoming signal from a given incoming direction to a given outgoing direction. Components of the CEDs can be used to redirect signals in the mm wave spectrum, in the sub 7 GHz spectrum, in the sub 6 GHz spectrum or in any other spectrum which may be used. Further, the components of the CEDs can be configured to make redirections of signals which appear in-phase in one or more of: a direction, an area, or a volume.

The coverage enhancing devices can be used for network management. The coverage enhancing devices can be used for beam management, panel management or both beam management and panel management. The coverage enhancing devices can be used for far-field propagation, near-field propagation or both far-field propagation and near-field propagation. The coverage enhancing devices can utilize one or more of: passive array panels, active array panels and intelligent surfaces to improve coverage and beamforming of signals.

The disclosed coverage enhancing devices can be one of a number of several types of devices, which can be used interchangeably herein. For example, the CEDs can be one or more of: reconfigurable intelligent surfaces (RISs), large intelligent surfaces (LISs), network configured repeaters, repeater nodes, repeater type devices, repeaters (such as regenerative and/or non-regenerative), intelligent surfaces and reconfigurable reflective devices (RRDs). The CEDs can have one or more antennas, such as one or more of: antenna panels, antenna elements, antenna inputs, antenna outputs and unit cells for meta-surfaces. The CEDs can have one or more receivers, for example low-power receivers. The CEDs can have one or more transmitters, such as an active component that provides amplification to a signal.

In one or more example wireless communication systems, the signals disclosed herein can be one or more of: energy, transmission, wave energy, FR1 and FR2 signals, 5G signals, 6G signals, sub-6 GHz, sub-THz, THz, electromagnetic energy, waves, electromagnetic plane waves, electromagnetic signals, plane signals, spherical waves, spherical signals, cylindrical waves, and cylindrical signals. As disclosed herein, waves and signals can be used interchangeably. Signals can include orbital angular momentum (OAM) signals. Signals may include signals with any polarization properties. The particular type of signal is not limiting.

As disclosed herein, the terms signal, message and data can be used interchangeably.

As used herein, the terms emitted, sent, and transmitted can be used interchangeably.

FIG. 5 is a signalling diagram illustrating an example communication 600 between a coverage enhancing device 500, a network node 400 and a wireless device 300.

The coverage enhancing device 500 may transmit, to the network node 400, capability signalling 502 indicative of a capability of the coverage enhancing device 500 to provide a location of at least one frequency component.

In the communication example of FIG. 5, the at least one frequency component comprises at least one carrier component.

In some examples, the control signalling comprises further information, such as an insertion loss of the CED associated with the location of the at least one frequency component. As used herein, the insertion loss of the CED (also referred to as reflection gain) may indicate a relative gain between locations of frequency components. The insertion loss of the CED may be defined as a ratio of an incident signal power and a reflected signal power at the CED. The insertion loss of the CED may depend on the hardware components of the CED.

The network node 400 may transmit, to the coverage enhancing device 500, a configuration signal 504 requesting the coverage enhancing device 500 to identify the location of the at least one carrier component.

In the example communication of FIG. 5, the coverage enhancing device 500 transmits, to the network node 400, control signalling 506 indicative of the location of the at least one carrier component to be used for a first channel between the network node 400 and the wireless device 300. The first channel is in addition to at least a second channel between the network node 400 and the wireless device 300. Put another way, the second channel between the network node and the wireless device may be a channel different from the first channel between the network node and the wireless device. For example, the first channel may be used by the network in addition to the second channel. In other words, the first channel can be seen as an additional channel. For example, the network node may use the first channel and the second channel in the communication with the wireless device.

The location of the at least one frequency component, such as a first carrier component, indicated by the control signalling 506 may be selected to maximise a channel gain value in the first channel between the network node 400 and a wireless device 300. For example, the channel gain value may be independent from the location of a second carrier component to be used for the second channel between the network node 400 and a wireless device 300. Therefore, the method may enable an enhancement of the transmission bandwidth between the network node 400 and a wireless device 300 whilst achieving sufficient channel gain in the first and second channels.

The capability signalling 502 may be useful to make the network node 400 aware of the capability of the CED 500 to provide the location of such at least one frequency component, such as the first carrier component, which allows for an optimisation of the channel gain. Likewise, the configuration signal 504 may be advantageous to make the CED 500 aware of the requirement from the network node 400 to provide the location of such at least one frequency component, such as the first carrier component, which allows for an optimisation of the channel gain.

The capability signalling 502 may indicate, when the CED 500 is connected to the wireless communication system 1, a capability according to which the CED 500 has a limitation on the locations of the at least one frequency component for a certain value of angle information. The capability signalling 502 may indicate, when the CED 500 is connected to the wireless communication system 1, a capability according to which the CED 500 has no limitation on the locations of the at least one frequency component for a certain value of angle information.

As used herein, “angle information” is understood as information based on a relative angular positioning of at least two components of a wireless communication system.

The configuration signal 504 may comprise user information indicated to the CED 500 as a reference to a Quasi-Colocation (QCL) resource, such as one or more of: a SS/PBCH block, a CSI-RS, and an SRS, wherein SS stands for Synchronization Signal, PBCH for Physical Broadcast Channel, CSI stands for Channel State Information, RS stands for Reference Signal, and SRS stands for Sounding Reference Signal. By using a QCL resource, the CED 500 may obtain angle information (such as beamforming vectors comprising an angle of arrival of a signal at the coverage enhancing device from the network node and an angle of departure of a signal from the coverage enhancing device to the wireless device). The CED 500 may provide the location of the at least one carrier component to be used for a first channel between the network node 400 and a wireless device 300 based on the angle information.

In one or more example methods, the location of the at least one carrier component is based on the angle information. In one or more example methods, the angle information comprises an angle, such as a spherical angle, between the coverage enhancing device and the wireless device. In one or more example methods, the angle information comprises an angle between the coverage enhancing device and the network node. In one or more example methods, the angle information comprises the angle between the coverage enhancing device and the wireless device and the angle between the coverage enhancing device and the network node (such as a network node-CED-wireless device angle pair). As used herein, “angle between the coverage enhancing device and the wireless device” is construed as the direction between the geometrical centre of the coverage enhancing device and the geometrical centre of the wireless device. As used herein, “angle between the coverage enhancing device and the network node” is construed as the direction between the geometrical centre of the coverage enhancing device and the geometrical centre of the network node.

In one or more example methods, the angle information enables the computation of steering vectors (such as the steering vectors s(f)=[s₁(f), s₂(f), . . . ] and u(f)=[u₁(f), u₂(f), . . . ] defined above) provided that a geometry of the CED is known.

In one or more example methods, the angle information is indicative of one more of: an input angle of the CED and an output angle of the CED. In one or more example methods, the angle information comprises an angle of arrival of a signal at the coverage enhancing device from the network node. In one or more example methods, the angle information comprises an angle of departure of a signal from the coverage enhancing device to the wireless device. In one or more example methods, the angle information comprises an angle of arrival of a signal at the coverage enhancing device from the network node and an angle of departure of a signal from the coverage enhancing device to the wireless device.

In one or more example methods, the angle information comprises a beam ID of the CED.

In one or more example methods, the control signalling is indicative of a plurality of locations of first frequency components, such as first carrier components. For example, with reference to FIG. 4, the locations of first carrier components may be about 4 GHz and about 8 GHz.

The coverage enhancing device 500 may receive, from the network node 400, a plurality of first sounding signals 508 over the plurality of first carrier components. The coverage enhancing device 500 may redirect the plurality of first sounding signals 508 to the wireless device. In other words, the network node 400 may transmit, to the wireless device 300, via the coverage enhancing device 500, the plurality of first sounding signals 508 over the plurality of first carrier components. The network node 400 may directly transmit, to the wireless device 300, the plurality of first sounding signals 508 over the plurality of first carrier components.

The wireless device 300 may transmit, to the coverage enhancing device 500, a plurality of first feedback messages 510 based on the plurality of first sounding signals 508. The coverage enhancing device 500 may redirect the plurality of first feedback messages 510 to the network node 400. The feedback messages can be seen as messages providing feedback on the channel sounding performed by the network node 400 using the sounding signals received by the wireless device 300 on the carrier components. In other words, the feedback messages can provide, to the network node 400, information on the channel sounding of carrier components performed by the network node 400. In other words, the network node 400 may receive, from the wireless device 300, via the coverage enhancing device 500, the plurality of first feedback messages based on the plurality of first sounding signals. The network node 400 may directly receive, from the wireless device 300, a plurality of first feedback messages based on the plurality of first sounding signals.

The network node 400 may determine, based on the plurality of first feedback messages, a location of a first carrier component, from the plurality of locations of first carrier components, to be used for the first channel between the network node 400 and the wireless device 300. For example, with reference to FIG. 4, the network node 400 may determine that the location of the first carrier component is about 4 GHz. Put another way, the plurality of first sounding signals and the plurality of first feedback messages may be advantageously utilised by the network node to select a location of a first carrier component, or any other first frequency component, among a plurality of locations of first frequency components. Although such plurality of locations of first frequency components may lead to similar channel gain values, the plurality of first sounding signals and the plurality of first feedback messages may be useful to select the location of the first carrier component on the basis of other communication criteria.

In one or more example methods, a location of a second carrier component to be used for the second channel between the network node and the wireless device is a predetermined location of the second carrier component. In one or more example methods, the location of the second carrier component to be used for the second channel between the network node and the wireless device may be randomly selected. For example, with reference to FIG. 4, when the location of the first carrier component is about 4 GHz (or about 8 GHz), the location of the second carrier component may be predetermined or randomly selected to be 2 GHz or 6 GHz without significantly affecting channel gain.

The network node 400 may transmit a plurality of second sounding signals 512 over a plurality of second carrier components. The coverage enhancing device 500 may redirect the plurality of second sounding signals 512 to the wireless device 300. In other words, the network node 400 may transmit, to the wireless device 300, via the coverage enhancing device 500, the plurality of second sounding signals over the plurality of second carrier components. The network node 400 may directly transmit, to the wireless device 300, the plurality of second sounding signals over the plurality of second carrier components.

The coverage enhancing device 500 may receive, from the wireless device 300, a plurality of second feedback messages 514 based on the plurality of second sounding signals 512. The coverage enhancing device 500 may redirect the plurality of second feedback messages 512 to the network node 400. In other words, the network node 400 may receive, from the wireless device 300, via the coverage enhancing device 500, the plurality of second feedback messages 514 based on the plurality of second sounding signals 512. The network node 400 may directly receive, from the wireless device 300, the plurality of second feedback messages 514 based on the plurality of second sounding signals 512.

The network node 400 may determine, based on the plurality of second feedback messages 514, a location of a second carrier component, from the plurality of second carrier components, to be used for the second channel between the network node 400 and the wireless device 300.

Although the plurality of locations of second frequency components may lead to similar channel gain values (such as any locations between 1 GHz and 9 GHz, with reference to FIG. 4), the plurality of second sounding signals and the plurality of second feedback messages may be useful to select the location of the second carrier component on the basis of other communication criteria.

When the control signalling is indicative of j locations of first frequency components and the network node 400 transmits k second sounding signals 512 over k second frequency components, the number of sounding signals needed for the determination of the location of the first frequency component and the second frequency component may be limited to j+k sounding signals if the j locations of first frequency components and the k locations of second frequency components are unique. This may reduce the complexity of (and the load required for) the determination of the location of the first frequency component and the second frequency component.

For some CED form factors (such as one or more of: uniform linear array members and uniform rectangular array members) and some phase shift implementations, the plurality of locations of second frequency components may be restricted to a number of discrete points. For other CED form factors (such as one or more of: uniform linear array members and uniform rectangular array members) and some phase shift implementations, the plurality of locations of second frequency components may be a continuous spectrum.

The network node 400 may transmit, to the coverage enhancing device 500, a confirmation signal 516 indicative of the location of the first carrier component, the second carrier component or both the first carrier component and the second carrier component. The confirmation signal 516 may be redirected, by the coverage enhancing device 500, to the wireless device 300. The confirmation signal 516 may be directly transmitted, by the network node 400, to the wireless device 300.

It may be envisaged that, in one or more example methods, a first channel between the network node and the wireless device is established after a second channel between the network node and the wireless device has been established. It may be envisaged that, in one or more example methods, a first channel between the network node and the wireless device and a second channel between the network node and the wireless device are pre-established, and a location of at least one frequency component is reconfigurable.

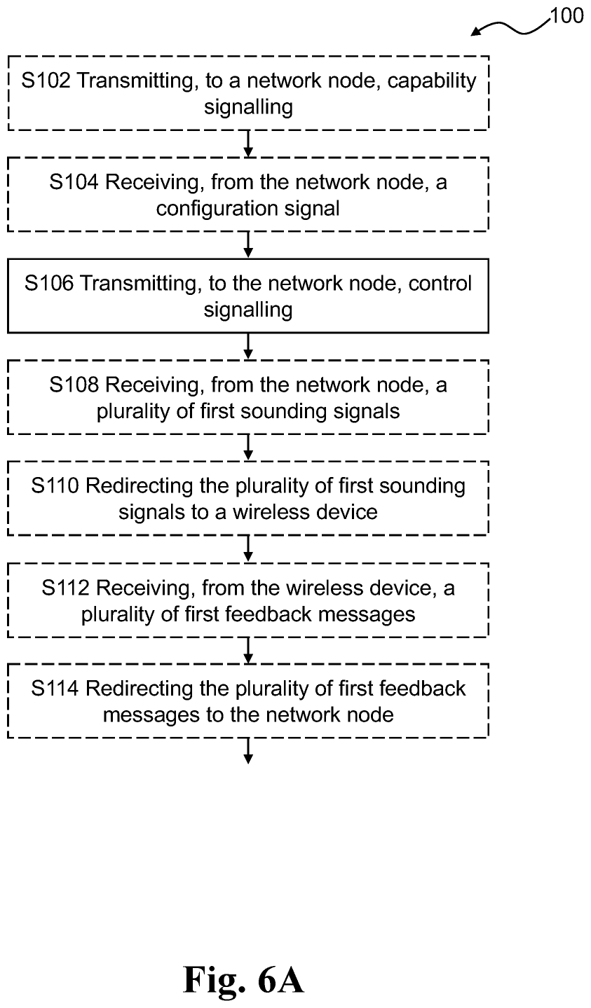

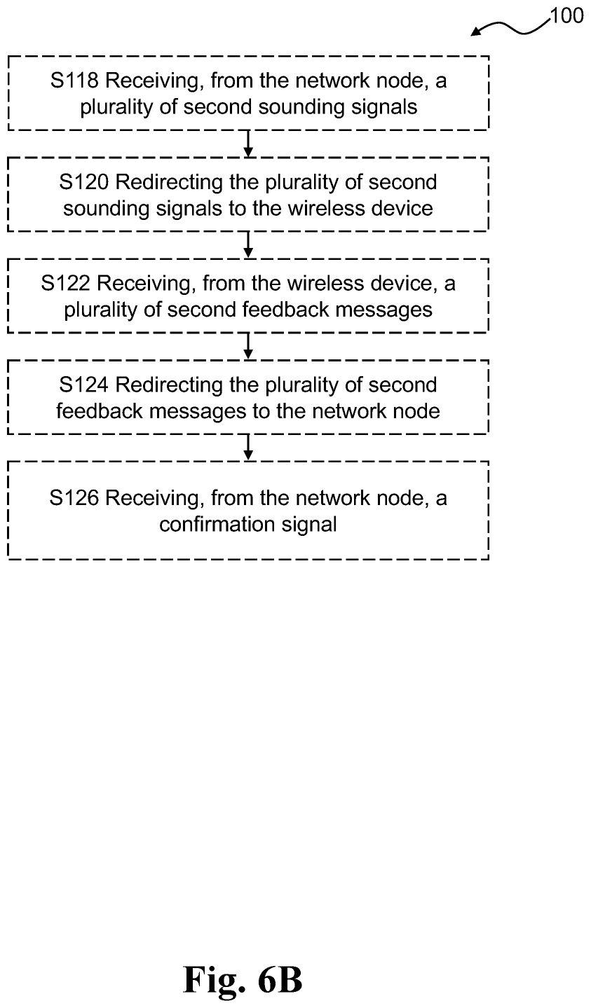

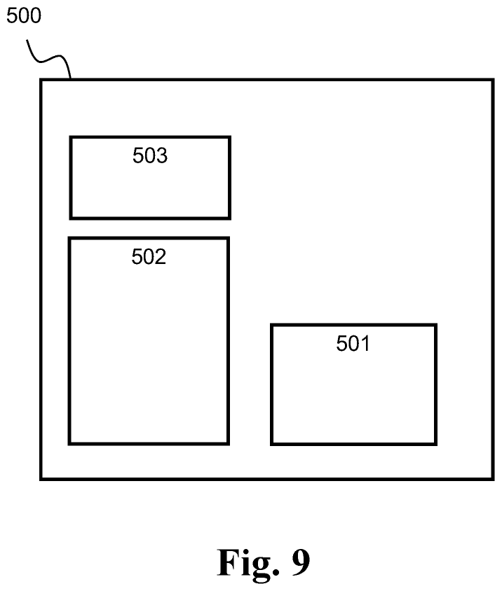

FIGS. 6A and 6B show a flow diagram of an example method 100, performed by a coverage enhancing device. The coverage enhancing device is the coverage enhancing device disclosed herein, such as coverage enhancing device 500 of FIG. 1, FIG. 2, and FIG. 9.

In one or more example methods, the method 100 comprises transmitting S102, to a network node, capability signalling. The capability signalling may be indicative of a capability of the coverage enhancing device to provide a location of at least one frequency component to be used for a first channel between the network node and a wireless device. The first channel may be in addition to at least a second channel between the network node and the wireless device.

In one or more example methods, the method 100 comprises receiving S104, from the network node, a configuration signal requesting the coverage enhancing device to identify the location of the at least one frequency component.

The method 100 comprises transmitting S106, to the network node, control signalling indicative of the location of the at least one frequency component to be used for the first channel between the network node and a wireless device.

In one or more example methods, the at least one frequency component comprises at least one carrier component.

In one or more example methods, the control signalling comprises further information, such as an insertion loss of the CED associated with the location of the at least one frequency component. Insertion loss can be defined as the ratio of the incident signal power and the reflected signal power at the CED, it depends on the hardware components of the CED.

In one or more example methods, the location of the at least one frequency component is based on an angle information. In one or more example methods, the angle information comprises an angle between the coverage enhancing device and the wireless device. In one or more example methods, the angle information comprises an angle between the coverage enhancing device and the network node. In one or more example methods, the angle information comprises the angle between the coverage enhancing device and the wireless device and the angle between the coverage enhancing device and the network node.

In one or more example methods, the angle information comprises one or more of: an angle of arrival of a signal at the coverage enhancing device from the network node and an angle of departure of a signal from the coverage enhancing device to the wireless device.

In one or more example methods, the control signalling is indicative of a plurality of locations of first frequency components.

In one or more example methods, the method 100 comprises receiving S108, from the network node, a plurality of first sounding signals over the plurality of first frequency components.

In one or more example methods, the method 100 comprises redirecting S110 the plurality of first sounding signals to the wireless device.

In one or more example methods, the method 100 comprises receiving S112, from the wireless device, a plurality of first feedback messages based on the plurality of first sounding signals.

In one or more example methods, the method 100 comprises redirecting S114 the plurality of first feedback messages to the network node.

In one or more example methods, the method 100 comprises receiving S118, from the network node, a plurality of second sounding signals over a plurality of second frequency components.

In one or more example methods, the method 100 comprises redirecting S120 the plurality of second sounding signals to the wireless device.

In one or more example methods, the method 100 comprises receiving S122, from the wireless device, a plurality of second feedback messages based on the plurality of second sounding signals.

In one or more example methods, the method 100 comprises redirecting S124 the plurality of second feedback messages to the network node.

In one or more example methods, the method 100 comprises receiving S126, from the network node, a confirmation signal indicative of the location of the first frequency component, the second frequency component or both the first frequency component and the second frequency component.

In one or more example methods, the confirmation signal is based on the plurality of first feedback messages and is indicative of a location of a first frequency component, from the plurality of locations of first frequency components, to be used for the first channel between the network node and the wireless device.

In one or more example methods, the confirmation signal is based on the plurality of second feedback messages and is indicative of a location of a second frequency component, from the plurality of locations of second frequency components, to be used for the second channel between the network node and the wireless device.

In one or more example methods, the confirmation signal is based on the plurality of first feedback messages and the plurality of second feedback messages, is indicative of a location of a first frequency component, from the plurality of locations of first frequency components, to be used for the first channel between the network node and the wireless device, and is indicative of a location of a second frequency component, from the plurality of locations of second frequency components, to be used for the second channel between the network node and the wireless device.

In one or more example methods, the location of the second frequency component to be used for the second channel between the network node and the wireless device is a predetermined location of the second frequency component.

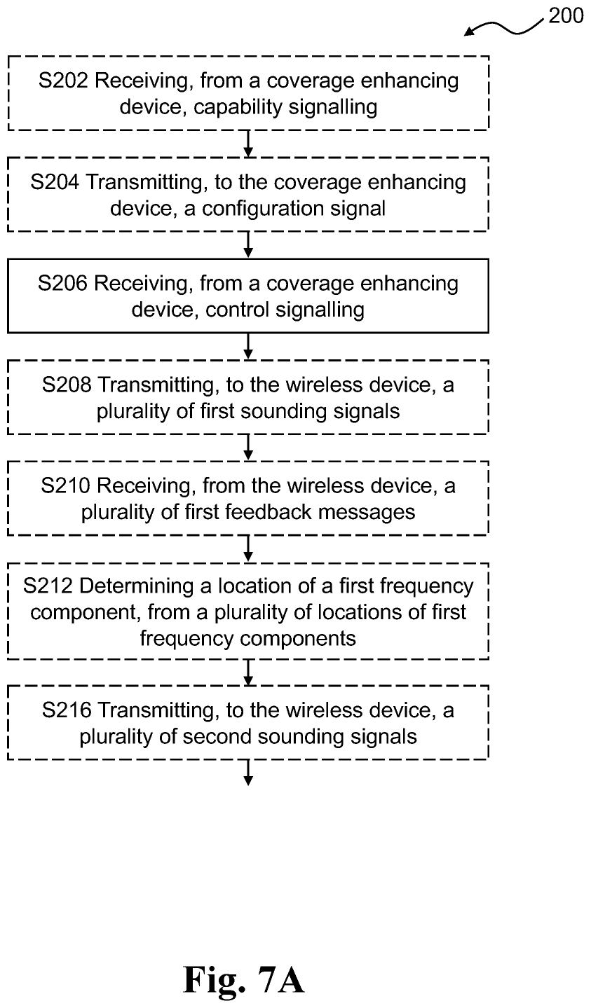

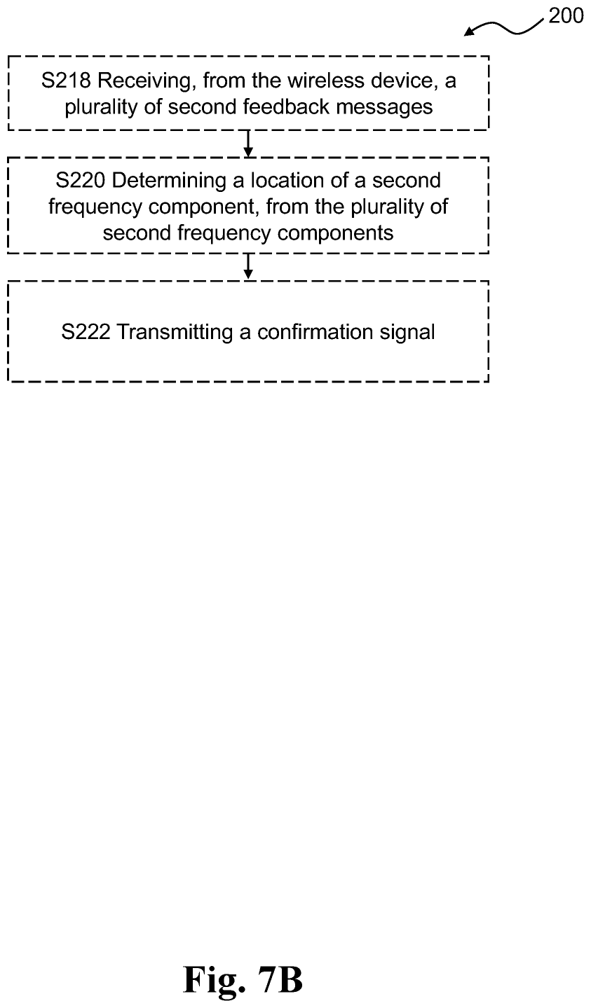

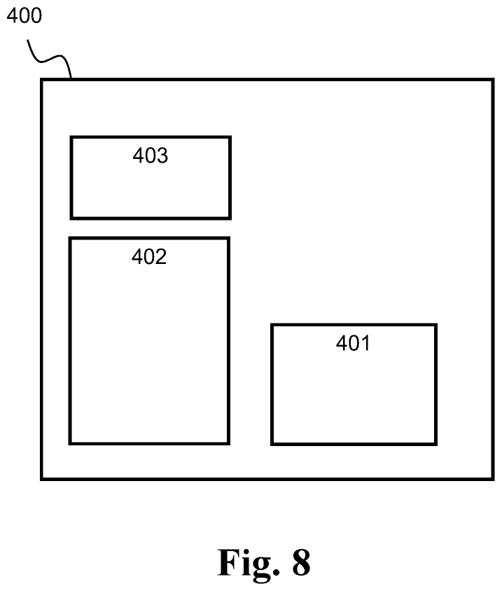

FIGS. 7A and 7B show a flow diagram of an example method 200, performed by a network node. The network node is the network node disclosed herein, such as network node 400 of FIG. 1, FIG. 2, and FIG. 8.

In one or more example methods, the method 200 comprises receiving S202, from a coverage enhancing device, capability signalling. The capability signalling may be indicative of a capability of the coverage enhancing device to provide a location of at least one frequency component to be used for a first channel between the network node and a wireless device. The first channel may be in addition to at least a second channel between the network node and the wireless device. For example, the first channel can be used by the network in addition to the second channel. For example, the network node can use the first channel and the second channel in the communication with the wireless device.

In one or more example methods, the method 200 comprises transmitting S204, to the coverage enhancing device, a configuration signal requesting the coverage enhancing device to identify the location of the at least one frequency component.

The method 200 comprises receiving S206, from the coverage enhancing device, control signalling indicative of the location of the at least one frequency component to be used for the first channel between the network node and the wireless device.

In one or more example methods, the at least one frequency component comprises at least one carrier component.

In one or more example methods, the control signalling comprises further information, such as an insertion loss of the CED associated with the location of the at least one frequency component.

In one or more example methods, the location of the at least one frequency component is based on an angle information. In one or more example methods, the angle information comprises an angle between the coverage enhancing device and the wireless device. In one or more example methods, the angle information comprises an angle between the coverage enhancing device and the network node. In one or more example methods, the angle information comprises the angle between the coverage enhancing device and the wireless device and the angle between the coverage enhancing device and the network node.

In one or more example methods, the angle information comprises one or more of: an angle of arrival of a signal at the coverage enhancing device from the network node and an angle of departure of a signal from the coverage enhancing device to the wireless device.

In one or more example methods, the control signalling is indicative of a plurality of locations of first frequency components.

In one or more example methods, the method 200 comprises transmitting S208, to the wireless device, a plurality of first sounding signals over the plurality of first frequency components.

In one or more example methods, the method 200 comprises receiving S210, from the wireless device, a plurality of first feedback messages based on the plurality of first sounding signals.

In one or more example methods, the method 200 comprises determining S212, based on the plurality of first feedback messages, a location of a first frequency component, from the plurality of locations of first frequency components, to be used for the first channel between the network node and the wireless device.

In one or more example methods, the method 200 comprises transmitting S216, to the wireless device, a plurality of second sounding signals over a plurality of second frequency components.

In one or more example methods, the method 200 comprises receiving S218, from the wireless device, a plurality of second feedback messages based on the plurality of second sounding signals.

In one or more example methods, the method 200 comprises determining S220, based on the plurality of second feedback messages, a location of a second frequency component, from the plurality of second frequency components, to be used for the second channel between the network node and the wireless device.

In one or more example methods, the method 200 comprises transmitting a confirmation signal S222 indicative of the location of the first frequency component, the second frequency component or both the first frequency component and the second frequency component.

In one or more example methods, the confirmation signal is based on the plurality of first feedback messages and is indicative of a location of a first frequency component, from the plurality of locations of first frequency components, to be used for the first channel between the network node and the wireless device.

In one or more example methods, the confirmation signal is based on the plurality of second feedback messages and is indicative of a location of a second frequency component, from the plurality of locations of second frequency components, to be used for the second channel between the network node and the wireless device.

In one or more example methods, the confirmation signal is based on the plurality of first feedback messages and the plurality of second feedback messages, is indicative of a location of a first frequency component, from the plurality of locations of first frequency components, to be used for the first channel between the network node and the wireless device, and is indicative of a location of a second frequency component, from the plurality of locations of second frequency components, to be used for the second channel between the network node and the wireless device.

The confirmation signal may be redirected, by the coverage enhancing device, to the wireless device. The confirmation signal may be directly transmitted, by the network node, to the wireless device.

In one or more example methods, the location of the second frequency component to be used for the second channel between the network node and the wireless device is a predetermined location of the second frequency component.

FIG. 8 shows a block diagram of an example network node 400 according to this disclosure. The network node 400 comprises memory circuitry 401, processor circuitry 402 and a wireless interface 403. The network node 400 may be configured to perform any of the methods disclosed in FIGS. 7A and 7B. The network node 400 may be configured to perform any of the methods disclosed herein.

The wireless interface 403 can be configured to communicate with a wireless device, such as the wireless device disclosed herein, using a wireless communication system.

The network node 400 is configured to receive (such as via the wireless interface 403), from a coverage enhancing device, control signalling indicative of a location of at least one frequency component to be used for a first channel between the network node and a wireless device, wherein the first channel is in addition to at least a second channel between the network node and the wireless device.

The wireless interface 403 is configured for wireless communications via a wireless communication system, such as a 3GPP system, such as a 3GPP system supporting one or more of: New Radio (NR), Narrow-band IoT (NB-IoT), Long Term Evolution, enhanced Machine Type Communication, LTE-M, millimetre-wave communications (such as millimetre-wave communications in licensed bands or unlicensed bands, such as device-to-device millimetre-wave communications in licensed bands or unlicensed bands), Non-Terrestrial Networks and sidelink communications.

Processor circuitry 402 is optionally configured to perform any of the operations disclosed in FIGS. 7A and 7B (such as any one or more of: S202, S204, S208, S210, S212, S216, S218, S220 and S222). The processor circuitry 402 is optionally configured to perform any of the operations, such as method steps, disclosed herein. The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may also be carried out via dedicated hardware or firmware, or one or more of: hardware, firmware, and software.

Memory circuitry 401 may be one or more of: a buffer, a flash memory, a hard drive, a removable media, a volatile memory, a non-volatile memory, a random access memory (RAM) and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 8). Memory circuitry 401 is considered a non-transitory computer readable medium.

Memory circuitry 401 may be configured to store the control signalling in a part of the memory.

FIG. 9 shows a block diagram of an example coverage enhancing device 500 according to this disclosure. The coverage enhancing device 500 comprises memory circuitry 501, processor circuitry 502 and a wireless interface 503. The coverage enhancing device 500 may be configured to perform any of the methods disclosed in FIGS. 6A and 6B. The coverage enhancing device 500 may be configured to perform any of the methods disclosed herein.

The wireless interface 503 can be configured to communicate with a wireless device, such as the wireless device disclosed herein, using a wireless communication system.

The coverage enhancing device 500 is configured to transmit (such as via the wireless interface 403), to the network node, control signalling indicative of a location of at least one frequency component to be used for a first channel between the network node and a wireless device, wherein the first channel is in addition to at least a second channel between the network node and the wireless device.

The wireless interface 503 is configured for wireless communications via a wireless communication system, such as a 3GPP system, such as a 3GPP system supporting one or more of: New Radio (NR), Narrow-band IoT (NB-IoT), Long Term Evolution, enhanced Machine Type Communication, LTE-M, millimetre-wave communications (such as millimetre-wave communications in licensed bands or unlicensed bands, such as device-to-device millimetre-wave communications in licensed bands or unlicensed bands), Non-Terrestrial Networks and sidelink communications.

Processor circuitry 502 is optionally configured to perform any of the operations disclosed in FIGS. 7A and 7B (such as any one or more of: such as any or more of S102, S104, S108, S110, S112, S114, S118, S120, S122, S124 and S126). The processor circuitry 502 is optionally configured to perform any of the operations, such as method steps, disclosed herein. The operations of the coverage enhancing device 500 may be embodied in the form of executable logic routines (for example, lines of code, software programs, etc.) that are stored on a non-transitory computer readable medium (for example, memory circuitry 501) and are executed by processor circuitry 502.

Furthermore, the operations of the coverage enhancing device 500 may be considered a method that the coverage enhancing device 500 is configured to carry out. Also, while the described functions and operations may be implemented in software, such functionality may also be carried out via dedicated hardware or firmware, or one or more of: hardware, firmware, and software.

Memory circuitry 501 may be one or more of: a buffer, a flash memory, a hard drive, a removable media, a volatile memory, a non-volatile memory, a random access memory (RAM) and any other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 9). Memory circuitry 501 is considered a non-transitory computer readable medium.

Memory circuitry 501 may be configured to store the control signalling in a part of the memory.

Examples of methods and products (network node and wireless device) according to the disclosure are set out in the following items:

Item 1. A method, performed by a coverage enhancing device, the method comprising:
transmitting, to a network node, control signalling indicative of a location of at least one frequency component to be used for a first channel between the network node and a wireless device, wherein the first channel is in addition to at least a second channel between the network node and the wireless device.

Item 2. The method of item 1, wherein the at least one frequency component comprises at least one carrier component.

Item 3. The method of any one of items 1 to 2, the method comprising:
transmitting, to the network node, capability signalling indicative of a capability of the coverage enhancing device to provide the location of the at least one frequency component.

Item 4. The method of any one of items 1 to 3, the method comprising:
receiving, from the network node, a configuration signal requesting the coverage enhancing device to identify the location of the at least one frequency component.

Item 5. The method of any one of items 1 to 4, wherein the location of the at least one frequency component is based on an angle information, and wherein the angle information comprises one or more of: an angle between the coverage enhancing device and the wireless device and an angle between the coverage enhancing device and the network node.

Item 6. The method of item 5, wherein the angle information comprises one or more of: an angle of arrival of a signal at the coverage enhancing device from the network node and an angle of departure of a signal from the coverage enhancing device to the wireless device.

Item 7. The method of any one of items 1 to 6, wherein the control signalling is indicative of a plurality of locations of first frequency components, the method comprising:
receiving, from the network node, a plurality of first sounding signals over the plurality of first frequency components;
redirecting the plurality of first sounding signals to the wireless device;
receiving, from the wireless device, a plurality of first feedback messages based on the plurality of first sounding signals;
redirecting the plurality of first feedback messages to the network node.

Item 8. The method of any one of items 1 to 7, the method comprising:
receiving, from the network node, a plurality of second sounding signals over a plurality of second frequency components;
redirecting the plurality of second sounding signals to the wireless device;
receiving, from the wireless device, a plurality of second feedback messages based on the plurality of second sounding signals; and
redirecting the plurality of second feedback messages to the network node.

Item 9. The method of any one of items 7 to 8, the method comprising:
receiving, from the network node, a confirmation signal indicative of a location of the first frequency component, a second frequency component or both a first frequency component and a second frequency component.

Item 10. The method of any one of items 1 to 9, wherein the location of the second frequency component to be used for the second channel between the network node and the wireless device is a predetermined location of the second frequency component.

Item 11. A method, performed by a network node, the method comprising:
receiving, from a coverage enhancing device, control signalling indicative of a location of at least one frequency component to be used for a first channel between the network node and a wireless device, wherein the first channel is in addition to at least a second channel between the network node and the wireless device.

Item 12. The method of item 11, wherein the at least one frequency component comprises at least one carrier component.

Item 13. The method of any one of items 11 to 12, the method comprising:
receiving, from the coverage enhancing device, capability signalling indicative of a capability of the coverage enhancing device to provide the location of the at least one frequency component.

Item 14. The method of any one of items 11 to 13, the method comprising:
transmitting, to the coverage enhancing device, a configuration signal requesting the coverage enhancing device to identify the location of the at least one frequency component.

Item 15. The method of any one of items 11 to 14, wherein the location of the at least one frequency component is based on an angle information, and wherein the angle information comprises one or more of: an angle between the coverage enhancing device and the wireless device and an angle between the coverage enhancing device and the network node.

Item 16. The method of item 15, wherein the angle information comprises one or more of: an angle of arrival of a signal at the coverage enhancing device from the network node and an angle of departure of a signal from the coverage enhancing device to the wireless device.

Item 17. The method of any one of items 11 to 16, wherein the control signalling is indicative of a plurality of locations of first frequency components, the method comprising:
transmitting, to the wireless device, a plurality of first sounding signals over the plurality of first frequency components;
receiving, from the wireless device, a plurality of first feedback messages based on the plurality of first sounding signals;
determining a location of a first frequency component, from the plurality of locations of first frequency components, to be used for the first channel between the network node and the wireless device.

Item 18. The method of any one of items 11 to 17, the method comprising:
transmitting, to the wireless device, a plurality of second sounding signals over a plurality of second frequency components;
receiving, from the wireless device, a plurality of second feedback messages based on the plurality of second sounding signals; and
determining a location of a second frequency component, from the plurality of second frequency components, to be used for the second channel between the network node and the wireless device.

Item 19. The method of any one of items 17 to 18, the method comprising:
transmitting a confirmation signal indicative of the location of the first frequency component, the second frequency component or both the first frequency component and the second frequency component.

Item 20. The method of any one of items 12 to 19, wherein the location of the second frequency component to be used for the second channel between the network node and the wireless device is a predetermined location of the second frequency component.

Item 21. A coverage enhancing device comprising memory circuitry, processor circuitry and a wireless interface, wherein the coverage enhancing device is configured to perform any of the methods of items 1 to 10.

Item 22. A network node comprising memory circuitry, processor circuitry and a wireless interface, wherein the network node is configured to perform any of the methods of items 11 to 20.

The use of the terms “first”, “second”, “third” and “fourth”; “primary”, “secondary”, “tertiary”, etc. does not imply any particular order (let alone a specific spatial or temporal order, or an order of importance). Rather the reverse, the terms “first”, “second”, “third” and “fourth”; “primary”, “secondary”, “tertiary” etc. are included to identify individual elements, that is, they are provided for labelling purposes with an aim to distinguish elements from each other. Furthermore, the labelling of a first element does not imply the presence of a second element and vice versa.

It may be appreciated that the figures comprise some circuitries, components, features or operations which are illustrated with a solid line and some circuitries, components, features or operations which are illustrated with a dashed line. Circuitries, components, features or operations which are delimited by a solid line are circuitries, components, features or operations which are comprised in the broadest example of an exemplary embodiment. Circuitries, components, features or operations which are delimited by a dashed line are examples which may be comprised in, or a part of, or are further circuitries, components, features or operations which may be taken in addition to circuitries, components, features, or operations of the broadest example represented by the solid line. It should be appreciated that these operations need not be performed in the presented order. The example operations may be performed in any order and in any combination. Furthermore, it should be appreciated that not all of the operations need be performed.

Other operations that are not described herein can be incorporated in the example operations. For example, one or more additional operations can be performed before, after, simultaneously or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” “features” or “devices” may be represented by the same item of hardware.

Language of degree used herein, such as the terms “approximately,” “about,” “generally” and “substantially”, represent a value, amount or characteristic close to the stated value, amount or characteristic that still performs a desired function or achieves a desired result. For example, the terms “approximately”, “about”, “generally” and “substantially” may refer to an amount that is: within less than or equal to 10% of, within less than or equal to 5% of, within less than or equal to 1% of, within less than or equal to 0.1% of, and within less than or equal to 0.01% of the stated amount. If the stated amount is 0 (for example, none or having no), the above recited ranges can be specific ranges instead of a particular % of the value.

The various example methods, devices, nodes, and systems described herein are described in the general context of method steps or processes, which may be implemented by a computer program product, embodied in a computer-readable medium (including computer-executable instructions, such as program code) and executed by computers in networked environments. A computer-readable medium may include removable and non-removable storage devices including, but not limited to: Read Only Memory (ROM), Random Access Memory (RAM), compact discs (CDs), digital versatile discs (DVD) and any other suitable storage device. Generally, program circuitries may include routines, programs, objects, components, data structures, etc. that perform specified tasks or implement specific abstract data types. Computer-executable instructions, associated data structures and program circuitries represent examples of program code for executing steps of the methods disclosed herein. The particular sequence of such executable instructions or associated data structures represents examples of corresponding acts for implementing the functions described in such steps or processes.

Although example features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a coverage enhancing device, the method comprising:
transmitting, to a network node, control signalling indicative of a location of at least one frequency component to be used for a first channel between the network node and a wireless device, wherein the first channel is in addition to at least a second channel between the network node and the wireless device.

2. The method of claim 1, wherein the at least one frequency component comprises at least one carrier component.

3. The method of claim 1, the method comprising:
transmitting, to the network node, capability signalling indicative of a capability of the coverage enhancing device to provide the location of the at least one frequency component.

4. The method of claim 1, method comprising:
receiving, from the network node, a configuration signal requesting the coverage enhancing device to identify the location of the at least one frequency component.

5. The method of claim 1, wherein the location of the at least one frequency component is based on an angle information, and wherein the angle information comprises one or more of: an angle between the coverage enhancing device and the wireless device and an angle between the coverage enhancing device and the network node.

6. The method of claim 5, wherein the angle information comprises one or more of: an angle of arrival of a signal at the coverage enhancing device from the network node and an angle of departure of a signal from the coverage enhancing device to the wireless device.

7. The method of claim 1, wherein the control signalling is indicative of a plurality of locations of first frequency components, the method comprising:
receiving, from the network node, a plurality of first sounding signals over the plurality of first frequency components;
redirecting the plurality of first sounding signals to the wireless device; receiving, from the wireless device, a plurality of first feedback messages based on the plurality of first sounding signals;
redirecting the plurality of first feedback messages to the network node.

8. The method of claim 1, the method comprising:
receiving, from the network node, a plurality of second sounding signals over a plurality of second frequency components;
redirecting the plurality of second sounding signals to the wireless device;
receiving, from the wireless device, a plurality of second feedback messages based on the plurality of second sounding signals; and
redirecting the plurality of second feedback messages to the network node.

9. The method of claim 7, the method comprising: receiving, from the network node, a confirmation signal indicative of a location of the first frequency component, a second frequency component or both a first frequency component and a second frequency component.

10. The method of claim 1, wherein the location of the second frequency component to be used for the second channel between the network node and the wireless device is a predetermined location of the second frequency component.

11. A method, performed by a network node, the method comprising:
receiving, from a coverage enhancing device, control signalling indicative of a location of at least one frequency component to be used for a first channel between the network node and a wireless device, wherein the first channel is in addition to at least a second channel between the network node and the wireless device.

12. The method of claim 11, wherein the at least one frequency component comprises at least one carrier component.

13. The method of claim 11, the method comprising:
receiving, from the coverage enhancing device, capability signalling indicative of a capability of the coverage enhancing device to provide the location of the at least one frequency component.

14. The method of claim 11, the method comprising:
transmitting, to the coverage enhancing device, a configuration signal requesting the coverage enhancing device to identify the location of the at least one frequency component.

15. The method of claim 11, wherein the location of the at least one frequency component is based on an angle information, and wherein the angle information comprises one or more of: an angle between the coverage enhancing device and the wireless device and an angle between the coverage enhancing device and the network node.

16. The method of claim 15, wherein the angle information comprises one or more of: an angle of arrival of a signal at the coverage enhancing device from the network node and an angle of departure of a signal from the coverage enhancing device to the wireless device.

17. The method of claim 11, wherein the control signalling is indicative of a plurality of locations of first frequency components, the method comprising:
transmitting, to the wireless device, a plurality of first sounding signals over the plurality of first frequency components;
receiving, from the wireless device, a plurality of first feedback messages based on the plurality of first sounding signals; and
determining a location of a first frequency component, from the plurality of locations of first frequency components, to be used for the first channel between the network node and the wireless device.

18. The method of claim 11, the method comprising:
transmitting, to the wireless device, a plurality of second sounding signals over a plurality of second frequency components;
receiving, from the wireless device, a plurality of second feedback messages based on the plurality of second sounding signals; and
determining a location of a second frequency component, from the plurality of second frequency components, to be used for the second channel between the network node and the wireless device.

19. The method of claim 17, the method comprising:
transmitting a confirmation signal indicative of the location of the first frequency component, the second frequency component or both the first frequency component and the second frequency component.

20. The method of claim 12, wherein the location of the second frequency component to be used for the second channel between the network node and the wireless device is a predetermined location of the second frequency component.
